(19) United States
(12) Patent Application Publication
(10) Pub. No.: US 2006/0198419 A1
(43) Pub. Date: Sep. 7, 2006

(54) Cemented electrode joint and process for curing the same

(76) Inventors: Allan Intermill, Strongsville, OH (US); Brian Bowman, Westlake, OH (US); William Varela, Parma Heights, OH (US)

Correspondence Address: WADDEY & PATTERSON, 1600 DIVISION STREET, SUITE 500, NASHVILLE, TN, 37203, US

(21) Appl. No.: 11/072,223

(22) Filed: Mar. 4, 2005

(51) Int. Cl. H05B 7/06

(52) U.S. Cl. 373/93

(57) ABSTRACT

A graphite electrode joint and method for forming the graphite electrode joint, wherein the method includes the steps of providing a first graphite electrode having at least one end; providing a second graphite electrode having at least one end; applying a thermally-curing adhesive material, such as cement, on one or more of the graphite electrodes at or near the ends thereof; joining together the first and second graphite electrodes having thermally-curing adhesive material thereon at their respective ends so as to form a joint therebetween; and curing the cement by passing electrical current across the joint.

### BACKGROUND OF THE INVENTION TECHNICAL FIELD

The present invention relates to carbon bodies, especially graphite electrodes, and a method for joining the graphite electrodes with improved stability. More particularly, the invention relates to a unique process for curing cemented electrode joints.

### BACKGROUND ART

In the steel industry, graphite electrodes are used in electrothermal furnaces, sometimes called electric arc furnaces, to melt metals and other ingredients to form steel. The heat needed to melt metals is generated by passing current through one or more electrodes and forming an arc between the electrode(s) and the metal in the furnace. Electrical currents in excess of 100,000 amperes are often used. The resulting high temperature melts the metals and other ingredients. Generally, the electrodes used in steel furnaces each consist of graphite electrode columns, that is, a series of individual electrodes joined to form a single column. In this way, as electrodes are depleted during the thermal process, replacement graphite electrodes can be joined to the column to maintain the desired length of the column so that it extends desirably into the furnace.

Conventionally, graphite electrodes are joined into columns via a pin (sometimes referred to as a nipple) that functions to join the ends of adjoining electrodes. Typically, both ends of a graphite electrode are comprised of female threaded sections. The pin takes the form of opposed male threaded sections, or tangs, which are capable of mating with one of the female threaded sections of each of the electrodes. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint.

As mentioned, during furnace operation current passes through the electrode to melt the steel and other metals in the furnace. A graphite arc furnace electrode must not only carry current to the arc, but it must do so while being constantly eroded away in the process. Around its circumference and at the top, near the joint, chemical oxidation and mechanical forces attack the electrode, causing it to weaken, crack and/or break, which may cause some or all of the remainder of the electrode, sometimes referred to as a “stub,” to fall into the molten steel mixture. Sometimes, the electrode cracks or becomes damaged due to the harsh shaking within the furnace that exists due to furnace operation; again, this may result in an electrode stub falling into the molten steel mixture. The joint between two electrodes in a column is one of the weakest points in the electrode column; thus, it is especially susceptible to degradation and/or breakage.

When an electrode stub falls into the molten steel mixture, it adds an impurity to the mix and, because the electrode is not completely used up in its desired current carrying capacity, it results in inefficient electrode consumption.

Attempts have been made to adhere electrodes to each other and to adhere electrodes to pins to stabilize the joint and minimize stub loss. For instance, in International application PCT/US02/10125, inventors Pavlisin and Weber disclose a “plug” formed of pitch and expandable graphite. When the plug is placed at the base of an electrode socket, the heat of the furnace causes the pitch to melt and the graphite to expand, forcing the melted pitch between the threads where it carbonizes and locks the joint together. Another joint locking system employed in the past has been to provide one or more holes in an electrode pin at or near each of its ends, and positioning pitch in the holes. Again, the heat of the furnace causes the pitch to melt and flow across the threads where it carbonizes and locks the joint in position.

Other attempts to lock the electrode at the joint have been made and comprise an electrode joint having first and second complementary threaded elements capable of being joined together to form the joint. One of the threaded elements has at least one slot at least partially along its length; one of the threaded elements includes a source of a flowable adhesive in fluid communication with the slot.

It is known to apply cement into and/or around the joint area to connect two electrodes. However, the conventional cement curing processes are time-consuming and cause expensive delays in furnace operation. Known curing processes are also disadvantageous because the curing process was necessarily performed on the shop floor, i.e., “off-furnace,” rather than over the furnace, i.e., “on-furnace.” The known curing processes that require the cement to be cured on the shop floor require the graphite electrode column to be moved from its location within the furnace to a predetermined area on the shop floor. While the electrode column is on the shop floor, it cannot be used to melt steel and thus the furnace is either not functioning or doing so at a less than desirable rate.

The aforementioned disadvantages were described for the more common electrodes having two female ends that are joined by a pin having opposed male ends. However, electrodes having opposing male and female ends are also known and the joint between these two types of electrodes are also susceptible to damage and/or breakage resulting in stub loss. It is desirable to provide a joint between electrodes having opposing male and female ends that minimizes stub loss and it is desirable to provide a process for joining these types of electrodes either off- or on-furnace.

What is desired, therefore, is an electrode joint having sufficient strength and integrity to improve electrode performance and to minimize stub loss. It is also highly desirable to achieve these benefits by cementing the electrodes to each other, and/or to a connecting pin, which cementing process incorporates an improved curing process. It is desirable to have the option of cementing the electrode to the electrode column and curing the assembly either on- or off-furnace.

### SUMMARY OF THE INVENTION

It is an aspect of the present invention to provide a graphite electrode joint that resists breaking and cracking during use, providing a more stable electrode column.

It is another aspect of the present invention is to provide a graphite electrode joint having improved resistance to stub loss.

It is yet another aspect of the invention to provide a method for adhering two electrodes together, which is simple, reliable and robust.

It is another aspect of the present invention to provide a method for joining two electrodes together, which can be accomplished either off- or on-furnace.

Still a further aspect of the invention is to provide a method for adhering two electrodes together with a thermally-curing adhesive material, which adhesive material can be cured either on- or off-furnace.

These aspects and others, which will become apparent to the artisan upon review of the following description, can be accomplished by providing a first graphite electrode having at least one end; providing a second graphite electrode having at least one end; joining the first and second graphite electrodes together at their respective ends to form a joint therebetween; applying a thermally-curing adhesive material on one or more of the graphite electrodes at or near the end thereof; and curing the thermally-curing adhesive material by passing electrical current through and/or across the joint.

In the most preferred embodiment, the thermally-curing adhesive material comprises cement.

The cement is cured by attaching positive and negative terminals across the joint. When power is supplied, current travels across the joint thereby curing the cement. Advantageously, if this curing process is short enough, the curing process may be conducted on-furnace, thereby reducing furnace down-time and maximizing furnace operation. Alternatively, if so desired, the curing process may be done on the shop floor.

It is to be understood that both the foregoing general description and the following detailed description provide embodiments of the invention and are intended to provide an overview or framework of understanding of the nature and character of the invention as it is claimed. The accompanying drawings are included to provide a further understanding of the invention and are incorporated in and constitute a part of the specification. The drawings illustrate various embodiments of the invention and together with the description serve to describe the principles and operations of the invention.

### BRIEF DESCRIPTION OF THE DRAWINGS

The structure and preferred embodiments of the invention can best be understood by reference to the accompanying drawings, in which:

FIG. 1 is a perspective view of an electrode column inserted into an electric arc furnace, whereby the electrode column comprises multiple joints constructed in accordance with the present invention;

FIG. 2 is a side view in partial cross section of two electrode columns inserted into the electric arc furnace of FIG. 1, where both columns comprise joints constructed in accordance with the present invention;

FIG. 3 is a side view of a holder holding the electrode column shown in FIG. 1, the female end of the column being approached by an electrode with an inserted pin, both the electrode ends and pin having thermally-curing adhesive material applied thereon;

FIG. 4 is a side view in partial cross section of the joined electrodes of FIG. 3;

FIG. 5 is perspective view of an electrode joint and insulation for applying around the joint, in anticipation of the curing process, which will occur on the shop floor; and

FIG. 6 is a schematic view of a power source connected across the joint of FIG. 4 for curing the thermally-curing adhesive material.

### DETAILED DESCRIPTION OF THE PREFERRED EMBODIMENT

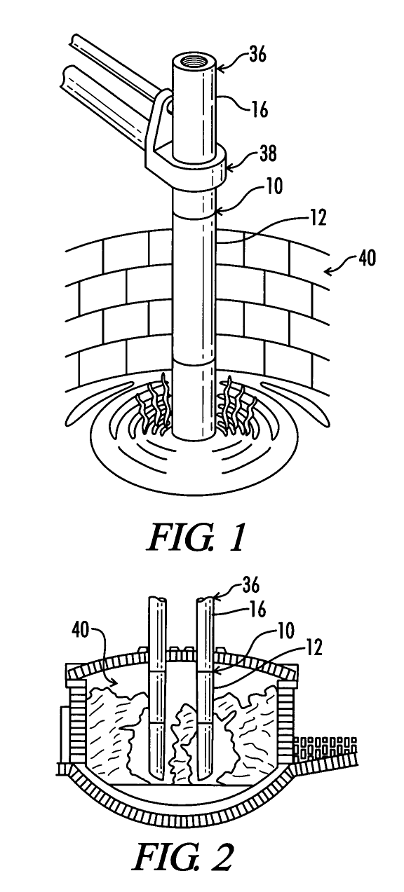

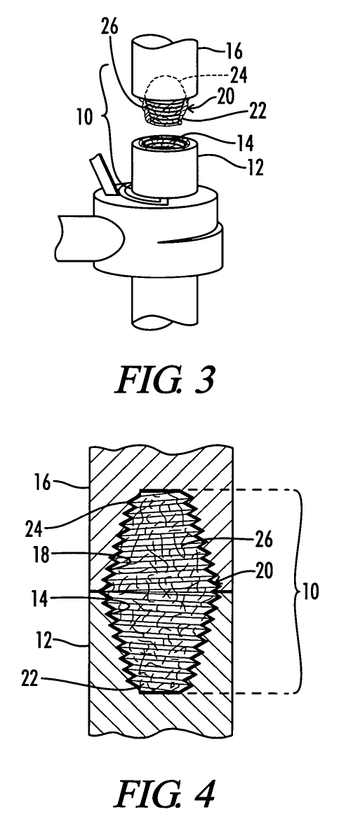

An electrode joint constructed in accordance with the present invention is generally shown by the reference numeral 10 and illustrated in FIG. 1. The electrode joint 10 is formed when a carbon body 12, such as a graphite electrode, having at least one female end 14 (best shown in FIG. 3) is connected to another carbon body 16, such as a graphite electrode, having at least one female end 18. See FIGS. 1, 3, 4. As best shown in FIGS. 3, 4, a pin 20 having at least two male ends 22, 24 is used to mate with the female ends 14, 18 of the first and second electrodes 12, 16, thereby forming joint 10 therebetween.

To desirably connect the electrodes 12, 16 at the joint 10, the present invention teaches the use of a thermally-curing adhesive material or mixture 26, which is inserted at least partially into and/or around the area of the joint 10. See FIGS. 3-6. Any suitable thermally-curing adhesive may be used. In the most preferred embodiment, the material comprises cement. In another preferred embodiment, the material comprises pitch. It should be understood that any suitable thermally-curing adhesive material may be used so long as it suitably connects the electrodes at the joint and can be cured in a manner disclosed herein.

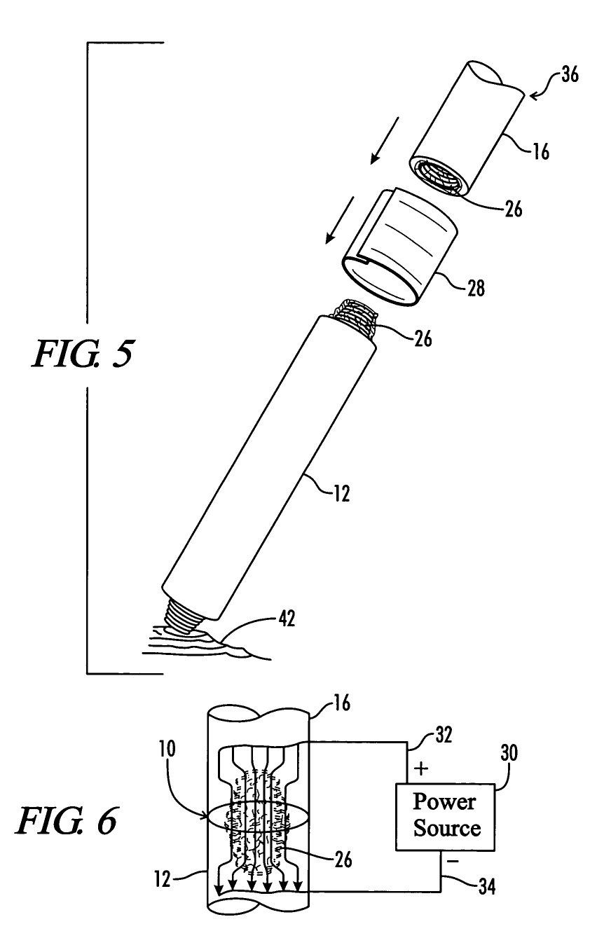

After the thermally-curing adhesive material 26 is applied at or near the ends 14, 18 of the electrodes 12, 14 and the joint 10, the joint 10 may optionally be insulated by insulation 28 to minimize heat loss. See FIG. 5. Any suitable insulation may be used. Insulation 28 is most desirable when the curing process described herein occurs on the shop floor, i.e., off-furnace.

The thermally-cured adhesive material 26 is cured by applying electrical current across at least a portion of the joint 10 by power source 30 as shown in FIG. 6. The joint 10 has a predetermined electrical resistance. The first and second electrodes 12, 16 have predetermined electrical resistances that are less than the electrical resistance of the joint 10, thereby creating a concentration of heat at substantially the joint area when the electrical current is applied across at least a portion of the joint 10. The power source 30 comprises a positive terminal 32 attached to one side of the joint 10 and a negative terminal 34 attached to the other side of the joint 10. The connections should be close to the joint 10 but sufficiently far enough from the joint to allow substantially even current flow across the electrode joint 10.

In one preferred embodiment, the power source 30 causes direct electrical current to flow across the joint 10. On a DC furnace, the power source comprises a rectifier system with high amperage rectifier system as is known in the art (not shown). The rectifier may be connected in any suitable manner, such as in parallel with the furnace rectifier system. The negative connection is preferably above the joint to be cured and the positive connection is preferably the furnace positive connection. In this embodiment, power for curing the joint 10 can supplement the furnace rectifier.

In an alternative embodiment, the power source, such as 30, causes AC electrical current to flow across the joint 10. Most preferably, the power source 30 allows substantially even current flow across at least a portion of the joint 10.

The heat up rate of the joint 10 can be controlled by controlling the amperage flowing through and/or across the joint 10. Advantageously, the power source 30 may be programmed so as to apply the electrical current to the joint 10 according to a predetermined schedule.

A method for forming a carbon body joint 10 in accordance with the present invention comprises the following steps. First, a first and second carbon body 12, 16 each having at least one end 14, 18 are provided. Then, a thermally-curing adhesive material 26, preferably cement, is applied on one or more of the carbon bodies 12, 16 at or near the ends 14, 18 thereof. The first and second carbon bodies 12, 16 are then joined together at their respective ends to form a joint 10 therebetween. Then the thermally-curing adhesive material 26 is cured by passing electrical current through the joint 10. The joint may be insulated by insulation 28 to reduce heat loss. See FIGS. 4-6.

Advantageously, curing the thermally-curing adhesive material 26 may be accomplished while the electrode column 36 is positioned by holder 38 at least partially into the electric arc furnace 40, sometimes referred to as on-furnace. See FIGS. 1, 2. Alternatively, the step of curing the thermally-curing adhesive material 26 may be accomplished while the electrode column 36 is on “off-furnace,” i.e., on the shop floor 42. See FIG. 5.

Stub loss is defined as the loss of the part of the electrode column lying from the arc tip to and sometimes including the joint closest to the arc tip. With the present invention, the electrode joint 10 causes the electrodes such as 12, 16 to be sufficiently connected that stub loss is reduced.

It should be understood that this method is suitable for use with any known electrodes, but is particularly well suited to graphite electrodes.

Additionally, it should be understood that the method of forming the electrode joint 10 of the present invention has been shown and described for use with electrodes having female ends, connected together by a pin having male tangs, for convenience only. The method of the present invention is also well-suited for use with electrodes having male/female ends, which may be connected to other electrodes having male/female ends, which form pinless joints.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

1. A method for forming a carbon body joint, comprising the steps of:
providing a first carbon body having at least one end;
providing a second carbon body having at least one end;
applying a thermally-curing adhesive material on one or more of the carbon bodies at or near the end thereof;
joining together the first and second carbon bodies having thermally-curing adhesive material thereon at their respective ends to form a joint therebetween;
providing a Power source having a positive and a negative terminal:
attaching the positive terminal to one side of the joint; and attaching the negative terminal to the other side of the joint; and
curing the thermally-curing adhesive material by passing electrical current across the joint.

2. The method of claim 1, wherein the first or second carbon body comprises a graphite electrode.

3. The method of claim 1, wherein the thermally-curing adhesive material comprises cement.

4. The method of claim 1, wherein the thermally-curing adhesive material comprises pitch.

5. (canceled)

6. The method of claim 1, further comprising the step of insulating the joint to reduce heat loss.

7. The method of claim 1, further comprising the step of providing an electrode column at least partially inserted into an electric arc furnace, the column comprising the joined first and second carbon bodies; and curing the thermally-curing adhesive material while the electrode column is positioned at least partially into the electric arc furnace.

8. A method for joining two electrodes, comprising:
providing a first electrode having at least one female end;
providing a second electrode having at least one female end;
providing a pin having at least two male ends, one male end for mating with the female end of the first electrode and the other male end for mating with the female end of the second electrode, thereby forming a joint between the first and second electrodes;
inserting a thermally-curing adhesive material at least partially into the joint;
providing a Power source having a positive and a negative terminal:
attaching the positive terminal to one side of the joint; and attaching the negative terminal to the other side of the joint; and
curing the thermally-curing adhesive material by applying electrical current substantially across the joint.

9. The method of claim 8, wherein either the first or second electrode comprises a graphite electrode.

10. The method of claim 8, wherein the thermally-curing adhesive material comprises cement.

11. The method of claim 8, wherein the thermally-curing adhesive material comprises pitch.

12. The method of claim 8 further comprising the step of providing a power source for causing the electrical current.

13. The method of claim 12, whereby the power source causes direct electrical current.

14. The method of claim 12, whereby the power source causes AC electrical current.

15. The method of claim 12, further comprising the step of programming the power source so as to apply the electrical current to the joint according to a predetermined schedule.

16. The method of claim 12, whereby the power source comprises a positive terminal and a negative terminal, the method further comprising the step of connecting the positive terminal to one side of the joint and connecting the negative terminal to the other side of the joint so as to allow substantially even current flow across at least a portion of the joint.

17. An electrode joint, comprising:
a first graphite electrode having at least one female end;
a second graphite electrode having at least one female end;
a pin having at least two male ends, one male end for mating with the female end of the first graphite electrode and the other male end for mating with the female end of the second graphite electrode, thereby forming a joint between the first and second graphite electrodes; and
a cementious mixture for insertion at least partially into the joint, which is cured by electrical current applied across at least a portion of the joint wherein the joint has a predetermined electrical resistance, whereby the first and second graphite electrodes have predetermined electrical resistances that are less than the electrical resistance of the joint, thereby creating a concentration of heat at substantially the joint area when the electrical current is applied across at least a portion of the joint.

18. (canceled)
